(19) United States
(12) Patent Application Publication
(10) Pub. No.: US 2006/0159871 A1
(43) Pub. Date: Jul. 20, 2006

(54) Paper compositions, imaging methods and methods for manufacturing paper

(75) Inventors: Satish Agrawal, Concord, MA (US); Clifford W. Parker, Brewer, ME (US)

Correspondence Address: WILMER CUTLER PICKERING HALE AND DORR LLP, 60 STATE STREET, BOSTON, MA, 02109, US

(73) Assignee: Performance Indicator, LLC, Topsfield, MA (US)

(21) Appl. No.: 11/270,222

(22) Filed: Nov. 8, 2005

Related U.S. Application Data
(60) Provisional application No. 60/626,067, filed on Nov. 8, 2004.

(51) Int. Cl. B41M 5/00; D21C 9/00

(52) U.S. Cl. 428/32.1; 162/100

(57) ABSTRACT

Paper compositions are provided that include an amine group-containing cationic polymeric material and a binder material. The paper compositions are particularly useful as receiver materials for images formed by electrophotographic imaging methods utilizing liquid developers. Also described are imaging methods that utilize the paper compositions as receiver materials and methods for manufacturing the paper.

### RELATED APPLICATION

The present application is based on and claims priority from U.S. Patent Application Ser. No. 60/626,067 filed on Nov. 8, 2004 and entitled PAPER COMPOSITIONS, IMAGING METHODS AND METHODS FOR MANUFACTURING PAPER.

### FIELD OF THE INVENTION

This application relates to a novel paper composition and, more particularly, to paper which includes at least one amine group-containing cationic polymer and is suitable for use in ink jet printing methods and electrophotographic copying and printing methods using dry or liquid toners, as well as to methods for forming images on the paper and a method for manufacturing the paper.

### BACKGROUND OF THE INVENTION

In the well known art of electrophotography a latent electrostatic image is initially formed on a photoconductive surface, typically by depositing a substantially uniform electrostatic charge on the photoconductive surface and exposing the charged surface to an imagewise pattern of radiation which corresponds to an image to be reproduced thereby discharging the photoconductive surface in an imagewise pattern. The latent electrostatic image is then developed by applying to it a composition of charged colored particles, which, depending upon the charge on the colored particles, that is, negative or positive, can be arranged to adhere to areas of the photoconductive surface having the higher potential or lower potential, respectively. The image thus formed on the photoconductive surface can then be transferred to a receiver material, typically paper, and adhered thereto so as to provide the desired reproduction. The development of the latent electrostatic image can be either by a “dry” process wherein a dry composition of colored particles is used or by a “wet” process wherein colored particles are dispersed in a liquid vehicle, typically an insulating, nonpolar liquid such as mineral oil or the like.

The developer composition, which is utilized to form the visible image, includes particles of the image-forming material, commonly referred to as “toner”, such as, for example, carbon black, or other colored pigments, or dyes, and a thermoplastic polymeric binder material. The thermoplastic polymeric binder materials together with other charge control agents and the colored pigments, also referred to hereinafter as pigmented polymer particles, are chosen so as to impart the desired charge triboelectrically to the image-forming material, as well as to provide an adequate degree of plasticity either at the temperature of the transferring surface or, where a specific fusing step is used to bind the image to the receiver surface, at the temperatures of the fusing step. The plasticity is necessary to fuse the pigmented toner particles together (cohesive strength), and to the paper (adhesive strength).

As mentioned previously, the visible image formed on the photoconductive surface is transferred to the receiver material. Such transfer can be made directly to a receiver material to form the final hard copy image. There are also known electrophotographic imaging methods in which the image formed on a photoconductive surface is first transferred to an intermediate transfer surface, also referred to hereinafter as ITS, and transferred from that surface to a final receiver material. Methods of this type are commonly referred to as “digital offset printing”. A method of this type, using a modulated laser beam to write the image on the photoconductor is described in U.S. Pat. No. 4,708,460.

According to the method described in U.S. Pat. No. 4,708,460, a photoconductive drum is charged electrostatically, exposed imagewise by means of a laser, and the resulting latent image developed by applying pigmented polymer particles in a liquid suspension, or emulsion, to the drum. The image formed on the drum is transferred to an ITS, whereupon the liquid vehicle, typically mineral oil or the like, is heated and a significant amount is driven off and the pigmented polymer particles are caused to melt or soften. Subsequently the image is transferred to a final receiver sheet and adhered thereto. In monochrome printing a single color image is formed on the receiver material. In multicolor printing two or more separate monochrome images are formed on the drum in registration and transferred to the receiver sheet.

The receiver materials, which can be useful in electrophotographic copying and printing, including digital offset printing, and in ink jet printing are required to have a number of characteristics. The receiver must be able to either rapidly bond-the pigmented polymer particles in the short contact time between the receiver and the transferring surface, or during the short duration of a receiver image fusing step; or, rapidly mordant the soluble ink when a plurality of ink drops are deposited on the paper. Hereinafter, any reference to dwell time refers to the duration of either the image transfer step or the fusing step for the case of electrophotographic printing methods. The rapid bonding in the case of electrophotographic methods, or mordanting in the case of ink jet printing methods will result in strong adhesion of the image-forming material to the receiver surface, which in turn will provide maximum retention of the pigmented polymer particles on the receiver surface, thereby resulting in high color saturation and image contrast. Also, where the printed image is strongly adhered to the receiver surface, the image is afforded more protection from scratching, scuffing, or marring during subsequent handling and processing.

For the case of electrophotographic methods, with strong image adhesion to the receiver surface during the transfer step, complete or substantially complete transfer of the pigmented polymer particles can take place without leaving any appreciable image residue on the transferring surface. In instances where there is incomplete transfer of the image to the receiver surface, and repeated printing of the same image is carried out, a significant residual image can be built up on the transferring surface, which can cause a ghost or spurious image to be seen when a different image is then formed on the transferring surface and subsequently transferred to the receiver. Additionally, for electrophotographic printing and copying using a liquid developer composition, the paper must be able to accept the liquid carrier for the pigmented polymer particles so as to not only create good adhesive strength but also create good cohesive strength.

For the case of electrophotographic methods receiver materials should also have a high surface strength so as to prevent unprinted area ghosting, or spurious images appearing on the receiver surface. When the surface strength of the receiver is not sufficiently strong at the temperatures and pressures of the transfer step, material can transfer from the receiver to the transferring surface, and with repeated printing of the same image, a significant deposit can be built up on the transfer surface in non-imaged areas. This build up can then create ghost or spurious images upon subsequent printing of a different image. When paper is used as a receiver, and given the presence of fillers (clay, calcium carbonate, titanium dioxide etc), and fibers, typically used in papermaking, when such fillers and fibers are inadequately adhered to the surface, a deposit of such materials can build up on the transferring surface, particularly when higher temperatures and pressures are used during image transfer, and as described above, cause ghost or spurious images.

Ink jet recording systems are also well known. Ink jet printers form an image by firing a plurality of discrete drops of ink from one or more nozzles onto the surface of a recording sheet placed adjacent the nozzles. The quality of images produced by such printers is greatly affected by the properties of the recording material, typically paper. To produce high quality images reliably it is necessary that the recording sheet rapidly absorb the ink carrier while retaining and binding the ink onto the paper surface so as to not only prevent the surface from being wet for an extended period of time since this would cause the ink to smear when successive sheets are stacked in the output tray of the printer but also to maximize ink retention on the paper surface to create high image density and minimize excessive spreading of the ink on the paper. Excessive, spreading will reduce image resolution and may also result in color distortion due to adjacent ink droplets intermixing. Additionally, even though the deposited ink was from an aqueous solution, the ink bound onto the paper surface should be waterfast.

U.S. Pat. No. 6,188,850 B1 describes a neutralized printing paper for use as a recording material in ink jet and electrophotographic printing methods. The paper includes a base paper and a cationic compound and starch applied to a surface of the base paper. The surface of the printing paper has a pH of from 6.0 to 7.5 and the pH of an interior of the printing paper is not lower than the surface pH value. The cationic compound is a strong acid salt of a compound having a functional group selected from the group consisting of primary, secondary and tertiary amino, quaternary ammonium, pyridyl, pyridinium, imidazolyl, imidazolium, sulfonium and phosphonium.

As the printing technologies that are commercially available proliferate there is a continuing need for new and improved receiver materials which are suitable for use as final receiver materials for more than one printing method such as for ink jet and electrophotographic imaging methods.

### SUMMARY OF THE INVENTION

In accordance with one or more embodiments of the invention, a paper composition is provided that is useful as a receiver material for images formed by a plurality of imaging methods.

In accordance with one or more embodiments of the invention, a paper composition is provided that is useful as a receiver material for images formed by electrophotographic imaging methods, including dry and wet copying and printing methods.

In accordance with one or more embodiments of the invention, a paper composition is provided that is useful as a receiver material for images formed by electrophotographic imaging methods wherein the image is formed by a liquid developer composition, and the image is either transferred to a receiver and fused thereto or transferred to an intermediate transfer surface prior to being transferred to the receiver.

In accordance with one or more embodiments of the invention, a paper composition is provided that is useful as a receiver material for images formed by ink jet imaging methods.

In accordance with one or more embodiments of the invention, a paper composition is provided that includes at least one amine group-containing cationic polymeric material and a binder material.

In accordance with one or more embodiments of the invention, an imaging method is provided wherein the paper composition of one or more embodiments of the invention is utilized as the receiver material.

In accordance with one or more embodiments of the invention, electrophotographic printing methods are provided including digital offset printing methods wherein a paper composition according to the invention is utilized as the receiver material.

In accordance with one or more embodiments of the invention, ink jet printing methods are provided wherein a paper composition of one or more embodiments of the invention is utilized as the receiver material.

In one aspect of the invention there is provided a paper composition, which may be bleached, that has a surface pH higher than the pH of the interior of the paper. The paper includes at least one amine group-containing cationic polymeric material and at least one binder material. The surface pH of the paper is generally in the range of from about 6.5 to about 10.5.

Depending upon the degree by which the surface pH of the paper is higher than the pH of the interior of the paper, in accordance with one or more embodiments of the invention, it is possible to tailor the properties of any specific paper composition to be generally optimized for a particular imaging method. For example, it is possible to tailor the properties of any specific paper composition to be generally optimized for either ink jet printing, dry or wet electrophotographic method, or for a variety of imaging methods including ink jet and dry and liquid electrophotographic methods. Generally, where the paper surface pH is closer to the pH of the interior of the paper, the paper will be generally optimized for ink jet and dry electrophotographic methods, and where the paper surface pH is significantly higher than the pH of the interior of the paper, it will be generally optimized for dry and wet electrophotographic methods. Also, for surface pH values that are intermediate to these two conditions, the paper can provide excellent performance for both ink jet and electrophotographic methods. As will be described in detail below herein, the properties enabling either dry or wet electrophotographic printing or ink jet printing or printing by a plurality of imaging methods can be obtained for any specific paper composition by adjusting upward the surface pH of the paper in accordance with the basicity, or pKb, of the cationic polymer material(s) and the interior pH of the paper.

In a preferred embodiment the paper includes from about 0.1 to about 18.0 lbs/3300 ft² of finished paper of at least one amine group-containing cationic polymeric material and from about 0.25 to about 10.0 lbs/3300 ft² of finished paper of at least one binder material and particularly preferably, from about 0.20 to about 10.0 lbs/3300 ft² of finished paper of at least one amine group-containing cationic polymeric material and from about 1.0 to about 7.0 lbs/3300 ft² of finished paper of at least one binder material.

In a preferred embodiment, the paper of the invention includes not more than about 20% by weight of mechanical fiber and, particularly preferably, not more than about 10% by weight of such fiber.

As is known by those skilled in the art, “mechanical fiber” refers to groundwood pulp and thermomechanical pulp. Groundwood pulp is defined as a mechanical wood pulp produced by pressing a barked log against a pulpstone and reducing the wood to a mass of relatively short fibers. Thermomechanical pulp is defined as a high-yield pulp produced by a thermomechanical process in which the wood particles are softened by preheating under pressure prior to a pressurized primary refining stage. This type of pulp replaces or reduces the chemical pulp component in newsprint or groundwood papers. See The Dictionary Of Paper, Fourth Edition, American Paper Institute, Inc., New York, N.Y., 1980, pp 205 and 416.

The paper composition of the invention may be of any type, including paper typically used in dry and wet electrophotographic copying and printing methods and ink jet printing methods, paperboard, or poster board, and packaging paper upon which images may be formed by various image-forming techniques. The base paper composition utilized in this invention for the application of the polymeric amine can be made by what is commonly referred to as either acid, alkali or neutral papermaking methods.

In another aspect of the invention there are provided imaging methods including ink jet printing methods and electrophotographic imaging methods, including dry and wet methods, and including both direct and indirect methods (offset) of image transfer, which utilize, as the receiver for the images formed, paper according to the invention.

According to another aspect of the invention there is provided a method for manufacturing paper of the invention which comprises adding the cationic polymeric material and the binder material, individually or in combination, at any point during the paper manufacturing method or at any point up to the formation of an image on the paper. For greater efficiency in maximizing surface retention of the cationic polymeric material, it is preferred to apply the material after the primary paper has been made, that is, cast at the wet end and dried. Hence, preferentially the polymeric material is applied either at the size press or any point after the size press up to the formation of the image on the paper.

### BRIEF DESCRIPTION OF THE DRAWING

For a better understanding of the invention as well as other objects and advantages and further features thereof, reference is made to the following detailed description of various preferred embodiments thereof taken in conjunction with the accompanying drawing wherein:

FIG. 1 is a diagram showing the paper path in one particular liquid electrophotography commercial printing machine, the HP/Indigo 1000 TurboStream digital offset printing machine.

### DESCRIPTION OF THE PREFERRED EMBODIMENTS

The paper composition of the invention may be of any type including paperboard, or poster board, packaging paper and papers typically used in copying and printing methods and comprises at least one amine group-containing cationic polymeric material and at least one binder material. The surface pH of the paper is higher than the pH of an interior part of the paper. In a preferred embodiment, the paper includes from about 0.1 to about 18.0 lbs/3300 ft² of finished paper of at least one amine group-containing cationic polymeric material and from about 0.25 to about 10.0 lbs/3300ft² of at least one binder material, and, particularly preferably, from about 0.2 to about 10.0 lbs/3300 ft² of finished paper of at least one amine group-containing cationic polymeric material and from about 1.0 to about 7.0 lbs/3300 ft² of finished paper of at least one binder material.

The paper may have any basis weight. Preferably, the basis weight suitable for paper used as the receiver in ink jet and electrophotographic copying and printing is in the range of from about 20 to about 400 pounds based on 500 sheets of 25″ by 38″. Further, the paper composition may have any desired gurly stiffness, measured according to standard TAPPI specification T-543 (Bending Resistance of Paper). In a preferred embodiment the paper has gurly stiffness in the machine direction of about 25 to about 6000 grams.

The cationic polymeric materials utilized in the paper composition of the invention include repeating amine units that are capable of forming cationic amine salts. The amine group-containing cationic polymer may be a homopolymer or a copolymer. The homopolymer or copolymer can be either in the base form, or partially, or wholly, in the cationic amine salt form. The cationic polymeric materials utilized according to the invention contain repeat amine functional units, which can be a primary (1°), secondary (2°), tertiary (3°), quaternary (4°), and/or heterocyclic amine.

The repeating amine units can be represented by the formula (I) or the formula (III): 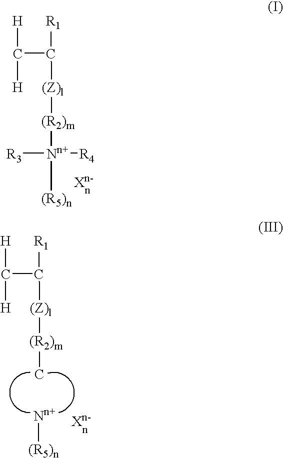
wherein,

R₁ is hydrogen or alkyl, preferably having from 1 to 4 carbon atoms:

R₂ is alkyl, preferably having from 1 to 4 carbon atoms, or aryl such as phenyl, benzyl or naphthyl;

R₃ and R₄ are each independently hydrogen, alkyl, preferably having from 1 to 4 carbon atoms, or aryl such as, phenyl or naphthyl; or R₃ and R₄, taken together with the nitrogen atom to which they are attached form a 3-10 member heterocyclic moiety;

R₅ is alkyl, preferably having from 1 to 4 carbon atoms or aryl such as phenyl or naphthyl;

X is an anion such as, for example, chlorine, bromine, tosylate, benzene sulfonate and the like;

Z is a linking group such as, for example, an ester, amide, sulfonamide, ether or other linking group;

1 is 0 or 1:

m is 0 or 1; and

n is 0 or 1.

With 1° amines, for which n=0, the amine group (NH₂) can be attached directly to the polymer backbone, (l and m=0), such backbone, as illustrated, being derived from ethylenically unsaturated monomers, or separated from the backbone by an R₂ group (m=1) which can be alkyl or aryl. The R₂ group can be connected to the polymer backbone either directly (l=0, m=1), or through a linking group such as an ester, amide, sulfonamide, ether, or other linking group (l=1, m=1). Examples of typical suitable 1° amines include poly(vinylamine) (R₁═H, R₃ and R₄═H, l and m=0), poly(allylamine) (R₁═H, R₃ and R₄═H, l=0, m=1, R₂=methyl), poly(aminostyrene) (R₁═H, R₃ and R₄═H, l=0, m=1, R₂=phenyl), etc.

The 2° amines, for which n=O are represented by either Formula (I) or Formula (M). For example, referring to Formula I, the 2° amines can result from an alkyl, e.g., methylvinylamine, (l=0, m=0, one of R₃ and R₄═CH₃ and the other of R₃ and R4 is hydrogen), or an aryl substitution at the nitrogen of the previously cited 1° amine (one of R₃ or R₄ is aryl and the other of R₃ and R₄ is hydrogen). The secondary amine (2°) may also comprise a saturated cyclic amine group such as aziridine, piperidine, or pyrrolidine. Referring to Formula (III), the secondary amine (n=0) may comprise a saturated secondary nitrogen containing cyclic moiety. Alternatively, the 2° amine may be formed from an unsaturated heterocyclic ring containing a secondary nitrogen atom. As described previously, the secondary amine group can be connected either directly or indirectly to the polymer backbone.

The 3° amines, for which n=0, can also be represented by either Formula (I) or Fomula (III). For example, referring to Formula I, the amine can result from either a dual alkyl, or aryl (R₃ and R₄ are each alkyl or aryl) or from an alkyl and an aryl (one of R₃ and R₄ is alkyl and the other is aryl), substitution at the nitrogen atom of the 1° amine, or a monosubstitution at the nitrogen of a 2° amine. The 3° amines may also comprise a heterocyclic amine group such as pyridine, e.g., poly (4-vinyl pyridine), pyrimidine, etc. Referring to Formula (III), the tertiary amine (n=0) may comprise an unsaturated heterocyclic ring containing a tertiary nitrogen atom. The 3° amine group can be attached to the polymer backbone either directly or indirectly as described above.

Quaternary amines for which n=1 can also be represented by Formula I or Formula III. For example, referring to Formula I, R₃, R₄ and R₅ are preferably each independently alkyl having from 1 to 4 carbon atoms, or aryl such as phenyl. Quaternary amines also have an associated counterion such as Cl⁻, Br⁻, tosylate, benzene sulfonate and the like. Alternatively, referring to Formula III (n=1), the quarternary amine may comprise an unsaturated tertiary nitrogen containing heterocyclic ring moiety. As described above with respect to the primary, secondary and tertiary amine repeating groups, the quarternary amine repeating groups can be attached to the polymer backbone either directly or indirectly.

Examples of cationic polymers containing quarternary amine groups are poly (2-methacryloxy ethyltrimethyl ammonium bromide). (Referring to Formula I: 1, m, and n are l, R₂ is ethyl, R₃, R₄ and R₅ are methyl, Z is an ester linkage, R₁ is methyl and the counterion X is bromide), and poly (2-vinyl-1-methylpyridinium bromide), wherein referring to Formula III, l and m are 0, n is 1 and X is bromide.

It should be noted that for quaternary amines, n=1 and the nitrogen atom will carry a positive charge.

The amine-containing cationic polymer can be either a homopolymer or a copolymer such as for example a copolymer containing repeating units of ethylenic groups and an amine having functional units as described above. A copolymer, which can be utilized according to the invention, can be represented by formula (II):

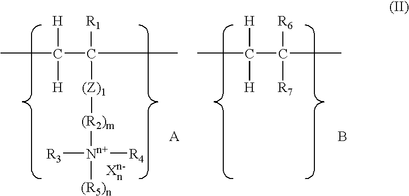

wherein R₁, R₂, R₃, R₄, R₅, Z, l, m and n are as previously defined and

R₆ is hydrogen, alkyl, preferably having from 1 to 4 carbon atoms, or aryl such as phenyl or naphthyl; and

R₇ is hydrogen, acrylate or nitrile.

In the copolymers of formula II, the repeating amine-containing functional unit (A) can be from about 20 mole % to about 90 mole % and the other repeat functional unit (B) is derived from ethylenically unsaturated monomers such as, for example, ethylene (R₆ & R₇═H), acrylates such as methacrylate, butyl acrylate, methyl methacrylate (R₆═H or methyl, and R₇ is an acrylate ), or, acrylonitrile (R₆═H, and R₇=nitrile), etc. and can be from about 80 mole % to about 10 mole %. For primary secondary and tertiary amines, n is 0 and for quaternary amines n is 1 and the nitrogen atom is positively charged.

For all amine functional units except for 4° amines, the fraction of amine which is cationic is dependent on the (Conjugate ) Acid Dissociation Constant Kₐ of the amine. The amine will be 50% protonated (cationic) at the pKa of the amine. At pH below the pKa the concentration of protonated amine will increase and at pH above the pKa the concentration of protonated amine will decrease. As with 4° amines, the protonated amine has an associated counter ion. The specific cationic polymer or polymers that are preferred for use in any specific ink jet imaging method or electrographic imaging method of the invention are dependent upon the state of the polymer, that is, the fraction of the polymer which is in the cationic, or protonated, state This is particularly the case for electrophotographic imaging methods which utilize liquid developers. The fraction of the polymer cationized will be dependent upon the surface pH of the paper, which in turn will be dependent on both the paper composition and the pH of the mixture by which the amine group-containing polymer is applied to the paper. This performance dependency on the pH of the paper surface together with the method deployed for selecting the appropriate polymer will be discussed below in detail.

Generally, for paper intended for use primarily as the receiver for wet electrophotographic imaging methods utilizing a non-polar carrier fluid, by rapidly immobilizing and binding the deposited pigmented polymer onto the paper surface, strong adhesion can be obtained. To accomplish this result the surface pH of the paper should be sufficiently high such that the polymeric amine is significantly deprotonated, or in the base form, so as to ensure compatibility with the carrier fluid which will result in rapid penetration and quick drainage of carrier fluid into the paper.

Generally, for paper intended for use primarily in ink jet printing methods, by rapidly immobilizing and binding the ink onto the surface of the paper, high image density and resolution can be achieved. This result can be achieved with both the protonated (ionic coupling) and deprotonated (hydrogen bonding) forms of the polymeric amine. Superior water fastness can be provided with the polymeric amine in the protonated form. Hence, for optimum ink jet printing performance, it is preferred that the surface pH of the paper be low enough to cause the polymeric amine to be significantly protonated.

For paper intended for use in dry electrophotographic methods, good adhesion can be obtained with the polymeric amine(s) in both the protonated and unprotonated forms. Experiments have shown, as will be discussed below, that for the pH range examined image quality was not dependent on the paper surface pH.

For any given polymeric amine, controlling the degree by which the surface pH of the paper is higher than the interior pH of the paper, as will be shown below herein, it is possible to tailor the properties of the paper for use in either ink jet printing methods, or for dry or wet electrophotographic printing methods or for a combination of electrophotographic and ink jet printing methods.

Any suitable binder materials may be utilized according to the invention including for example, starches such as non-ionic starches, starch derivatives such as, but not limited to, etherified and esterified starches and hydrophobically modified starches, latexes, proteins, alginates, vegetable gums and cellulose derivatives such as, for example, carboxymethylcellulose, hydroxymethylcellulose and the like.

For electrophotographic printing methods, it has been found that the effectiveness of the paper in strongly adhering the pigmented polymer particles to the paper surface is a function of a number of factors including the plasticity, or mobility, of the cationic polymeric material, that is, its ability to rapidly come in contact with the pigmented polymeric toner particles at the receiver temperature during image transfer or fusing. The plasticity, or mobility, of the cationic polymeric material is a function of the softening temperature of the material. This property of the cationic polymeric materials can be ascertained from their Vicat softening temperature. (See ASTM Test D1525-00 Standard Test Method For Vicat Softening Temperature of Plastics). Preferably, the Vicat softening temperature of the cationic polymeric material should be less than the receiver surface temperature during the image transfer or fusing step. Further, the shorter the dwell time of the image transfer or fusing step, it is preferred that the Vicat softening temperature should be lower than the receiver surface temperature by a greater extent. In a particularly preferred embodiment, the cationic polymeric material should have a Vicat softening temperature of from about 10° C. to about 100° C. below the receiver surface temperature for dwell times in the range of 1500 to 250 milliseconds. For a preferred embodiment, the receiver surface temperature, when in contact with an intermediate transfer surface at a temperature in the vicinity of 125° C. (low end of ITS surface temperature range) for dwell times of 1000 milliseconds, may be in the vicinity of about 90° C. For such a preferred embodiment, Vicat softening temperatures equal to, or less than about 90° C. are preferred. The receiver surface temperature during an image fusing step, which can be practiced in dry or wet electrophotographic methods, and which is generally present in dry electrophotographic methods, can be higher. Fusing temperatures deployed typically range from about 100° C. to about 250° C. In these embodiments of the image-forming methods of the invention, the Vicat softening temperature of the cationic polymeric material could be up to about 180° C.

The Vicat softening temperature of the cationic polymeric materials is dependent upon a number of factors. Such factors include the type of cationic polymeric material, i.e., whether a homopolymer or a copolymer, and the particular chemical type of the repeat functional units. A majority of the polymeric amine cationic polymers tested are water soluble and also have low boiling points. Hence, they will have adequate mobility for rapid interaction with either ink in hydrophilic carriers, or with dry or dispersed pigmented polymers under the image transfer conditions.

Image adhesion is also a strong function of the retention of the cationic polymer at or near the paper surface, which is dependent, in part, on the viscosity of the cationic polymer mixture and the method by which it is applied to the paper. In general, the higher the viscosity, with the upper limit being dependent on the application method selected, the lower will be the penetration of the cationic polymer into the paper, and the higher the concentration of the cationic polymer at or near the paper surface. Other factors which influence the viscosity of the mixture and hence the retention of the cationic polymer material at or near the paper surface include the molecular weight of the polymer, the degree of salt formation, the type of counter ion, and the pH of the mixture.

Generally, the cationic polymer material should be compatible with the pigmented polymer material, or inks, so as to ensure rapid bonding. Additionally, the cationic polymeric material should also be compatible with either the pigmented polymer carrier fluid for wet electrophotographic methods or, with the ink carrier or ink solvent used for ink jet printing methods so as to ensure absorption of the carrier fluid into the paper for both good cohesive and adhesive strength of the image. It has been found, as will be shown below, that different cationic polymers while providing excellent adhesion of pigmented polymer to paper surface, and good cohesive strength of pigmented polymer on the paper, can differ markedly in the time required after printing to achieve such results. While there is no intention to be bound by any specific theory it is believed that for either wet electrophotographic printing methods or ink jet printing methods the rate at which good adhesion and cohesion is achieved on the paper surface after printing is dependent upon the rate at which the carrier fluid penetrates into the paper.

Considering wet electrophotographic printing methods, those cationic polymeric materials, such as for example certain quarternary ammonium polymers, that are not easily wetted by the carrier fluid, which typically is non-polar mineral oil, cause slower penetration of the carrier fluid into the paper with correspondingly lower immediate adhesion and require greater elapsed time before the desired adhesion and cohesion can be achieved. Similarly, with primary, secondary or tertiary amines on the paper surface, the larger the fraction of polymer in the cationized form, the lesser will be the penetration rate of the non-polar carrier fluid into the paper resulting in poorer adhesion immediately after printing, and will require greater elapsed time before the desired adhesion and cohesion can be achieved. In extreme cases, when there is very high incompatibility of the polymeric amine and a specific carrier fluid, there may be almost no penetration of the carrier fluid into the paper and good adhesion may be very difficult to achieve even several days after printing. It should be understood, as stated above, that beyond compatibility with the carrier fluid the cationic polymer also should be compatible with the pigmented polymer or ink deployed in the imaging modality for rapid interaction.

Similarly, for ink jet printing methods wherein the ink carrier or solvent is typically a polar material such as water, and where the paper surface has a significant hydrophobic character, either because of the binder used alongside the polymeric amine, or because the polymeric amine is a copolymer with a hydrophobic species, the carrier or solvent will not drain rapidly from the paper surface resulting in poor immediate adhesion or be subject to smearing.

The paper of the invention provides rapid immobilization and binding of the colorants to provide very good surface adhesion, high image density and resolution for electrophotographic and ink jet printing methods The paper also absorbs liquids at a rapid enough rate so as to create strong adhesion after printing and not be subject to unacceptable adhesion for either wet electrophotographic methods which typically use insulating non-polar fluids such as aliphatic hydrocarbons as carrier fluids, or smearing for ink jet printing methods which typically use polar carriers or solvents, or for a variety of printing modalities including electrophotographic and ink jet methods.

For images formed by various electrophotographic imaging methods, the paper of the invention provides complete or at least substantially complete transfer of pigmented polymer particles used to form the image on the paper surface. Substantial transfer of the pigmented polymer particles to the paper surface significantly reduces or essentially eliminates any “ghost” images that can result from any image residue remaining on the transfer surface.

The paper of the invention also has a hard surface with strongly adhered filler materials and paper fibers which is particularly advantageous in a preferred digital offset printing method of the invention for the conditions of the image transfer from the intermediate transfer surface to the paper as will be described in detail below herein. In such digital offset printing methods the hard surface of the printing paper significantly reduces or substantially eliminates any intermediate transfer surface memory, or ghosting, which can result in undesired “ghost” or spurious images on the receiver from material transferred to the transfer surface in non image areas.

The paper of the invention also imparts superior water fastness to the images printed by ink jet modalities

The amine group-containing cationic polymeric and binder materials can be applied to one or both sides of the paper and can be applied either in the form of solutions, emulsions or dispersions of the polymers or copolymers or as combinations thereof. When reference is made herein to a polymer “mixture”, it should be understood that any such form is included. The cationic polymeric materials and the binder materials may be applied in combination or separately.

As mentioned above, quarternary amines will have an associated counterion. Additionally one can also use salts of primary and secondary amine polymers. Typical suitable salts include ammonium salts of acids-such as chlorides, or salts of weak acids such as polyvinylamine acetate, or polyallylamine acetate and the like. If the chosen method for applying the polyvalent metal salts is during papermaking, the selection should be made so as to minimize or avoid undesirable interactions with other paper making materials.

It is preferred to apply the cationic polymeric material to the paper from a polymer mixture, which has a viscosity sufficiently high to ensure maximum retention of the cationic polymer at or near the surface of the paper.

Selection of a specific cationic polymer or polymers for a particular paper composition and the optimum amount(s) can be carried out by standard experimental test practices. The selection can be greatly simplified by the use of a test method which simulates the environment of either image transfer, or image fusion, to the receiver or ink jet printing. While the use of such a method can be fairly general and cover a broad range of electrophotographic and ink jet printing methods, the specific ranges of the variables will depend upon the specific electrophotographic method or ink jet printing method.

Preparation of a Base Paper

A mixture comprising approximately 50% NHWK and 50% Softwood Sawdust Kraft pulp was subjected to maceration through a beating treatment. This pulp was used for making the primary paper. To this pulp material Calcium carbonate was added as the filler. Other additives included an opacifier, alkylketene dimer or AKD as internal size, Alum, and cationic starch as a bonding agent. The resultant slurry was formed into a primary paper substrate using conventional papermaking processes. To this paper substrate was added a hydrophobically modified starch, sold as FK-85 by National Starch, at coverage of approximately 4% of the basis weight of the paper by means of a conventional size press. The base paper thus produced had a basis weight of 90 grams per square meter. The surface pH of this paper sheet without the polymeric amine, hereinafter referred to as the base paper, was measured using Tappi Surface pH test Method T-529-OM-88 and found to be 6.55. This pH measurement, that is, measurement of the base paper surface pH prior to the application of the cationic amine, hereinafter will be referred to as the pH of the interior of the paper. The paper surface pH measurements after application of the polymeric amine containing solution were measured using the Tappi Surface pH method referred to above.

A suitable method for screening cationic polymeric materials will now be described in detail by way of an example directed to the digital offset liquid electrophotographic methods carried out using suitable electrophotographic printing machines. By way of example only and not as a limitation, reference is made to one family of machines, the HP/Indigo (Hewlett Packard) electrophotographic printing machine models 1000 through 4000, all of which employ an intermediate transfer surface (ITS). The paper of the invention can be used as a receiver for images formed with other such copying machines.

A specific test apparatus is a transfer press such as, for example, an AW-3000 Transfer Press made by Airwave Inc., Cincinnati, Ohio. Similar devices made by other manufacturers are commercially available and may be used for this purpose. The press consists of a heated platen with a lever that can serve as the base for the ITS material. Once the ITS material is affixed to the platen, it can be used to apply pigmented polymer to the paper surface under heat and pressure. The temperature of the platen is regulated to approximately simulate the receiver surface temperatures typically encountered in the HP/Indigo digital offset printing machines mentioned above. The HP/Indigo digital printing machines typically have ITS surface temperatures of from about 125° C. to about 180° C., resulting in receiver surface temperatures in the vicinity of 90° C. for the lower end of the ITS range. Although not mandatory, it is desirable to use an intermediate transfer surface material similar to the one that is used in the actual printing machine. For the HP/Indigo printing machines mentioned above, an identical ITS material, that is, HP/Indigo product designation MPS 2177-42 was selected. Further, the surface temperature of the ITS in the test apparatus was set at 105° C. for a majority of the testing so as to achieve a paper surface temperature in the vicinity of 90° C. for 1000 millisecond dwell time. The selected ITS temperature for the test is somewhat lower than the lower end of the range of ITS temperatures stated above. This was done so as to increase test selectivity for the chosen dwell time of 1000 millisecond, which was found to be easier to control.

As stated earlier, the cationic polymer should be compatible with both the pigmented polymer and the carrier fluid in which it is dispersed. Since the composition of the specific pigmented polymer toner particles used in any commercial electrophotographic printing or copying machine is typically not in the public domain, it is preferable to use the pigmented polymer particles actually used in the machine of interest. Thus, the black pigmented polymer available from HP/Indigo having the product designation MPS 2131-42 was used. The same test can be repeated for other color pigmented polymers. Generally, for this practice of liquid electrophotography, it has been found that when the cationic polymer is a good bonding agent for the chosen black pigmented polymer, it will also satisfactorily bond to the pigmented polymers of other colors.

In operation, the black pigment was diluted with mineral oil, specifically that available from HP/Indigo with a product designation MPS 2017-43, the pigmented polymer dispersant, and applied to the ITS, which was affixed to the platen of the transfer press. In general, the higher the coverage of the pigmented polymer on the ITS surface, the greater is the test sensitivity. Consequently, the coverage of the black pigmented particles to be applied to the ITS, was established by applying enough pigmented polymer particles so as to achieve an image density of about 1.40 or higher on the paper surface. Higher coverages of the pigmented polymer result in greater sensitivity of the test to carrier fluid penetration into the paper, which is manifested by greater discrimination among different cationic polymers for adhesion results immediately after printing.

The transfer press platen was then brought in contact with the paper receiver containing the cationic polymer being tested. A majority of the tests described below have been carried out at dwell time 1000 milliseconds.

The paper samples with the transferred black-pigmented polymer were then tested for adhesion efficacy via either cellophane tape, that is, Highland® Clear 6200, or Scotch Drafting Tape® Brand 230, available commercially from 3M Corporation, one hour after transferring pigment to the paper surface. The tape was applied uniformly to the printed surface and a 1 Kg weight roller was applied to the paper surface twice to get good tape adhesion to the pigmented polymer on the paper surface. The tape was then pulled away from the printed surface. Subsequently, the test sample was scanned with an Expression 1600 scanner (Epson. Corp.), and the scanned sample analyzed for the percentage of the material removed by the tape. A majority of the tests were done at very high Black Pigmened polymer coverages so as to increase the sensitivity of the test to carrier fluid penetration into the paper and thereby provide a means for discriminating adhesion results immediately after printing. Even though the adhesion was measured one hour after pigment transfer, it was found that the results correlated well with adhesion data measured immediately after printing on actual HP/Indigo machines such as HP/Indigo Ultrastream 3000.

Table 1 shows the results obtained with commercially available digital offset printing papers. It can be seen from the test data that there are several papers commonly used in digital printing that did not provide good adhesion to HP/Indigo pigments. It can also be seen from the data that if the dwell time is reduced to 250 milliseconds the adhesion results obtained from the above test indicate even poorer adhesion.

In Table 2, the adhesion data are presented as a function of different types of cationic polymers. The description and sourcing of all the compounds tested are listed in Table 7. It can be seen from the data in Table 2 that primary amines, such as polyallylamine hydrochloride or polyvinylamine hydrochloride or a polymeric vinylamine made by BASF (Catiofast VFH) have adhesion test losses that are approximately 20% or lower, which are substantially better than the approximately 40% loss of the base paper before application of the cationic polymer to the paper. The cationic polymer coverages are approximately in the range from 1-3 lb/3300 sq ft. (3300 sq. ft. is considered a ream.) It will be appreciated that at higher coverages the losses, in general, will be lower. A secondary amine such as poly N-methylvinylamine, exhibited excellent adhesion (less than 10% loss) at coverage of 2.74 lbs/3300 sq ft. The heterocyclic (tertiary) amine, poly (4-vinylpyridine) also showed good adhesion efficacy with losses of about 13 % at coverage of 1.56 lbs/3300 sq ft. There is also shown an example of a quarternary ammonium compound, poly(2-methacryloxy ethyltrimethyl ammonium bromide), which exhibited good adhesion efficacy with adhesion loss of approximately 20%.

In Table 3, the adhesion data are presented as a function of pH. It can be seen that at lower pH, where the polymer is substantially cationized, the adhesion losses were very high. Thus, poly(allylaminechloride), coated from a solution of pH 2.37 and resulting in a paper surface pH after coating of 6.0 showed losses of 83%, significantly worse than that of the base paper loss at 38.3% (See Table 1) to which the primary amine is applied. However, as the coated surface pH is increased to pH 8.4 the losses decreased from 83% to 21.4%. Although, not wishing to be bound to a particular theory or mechanism, it is our belief that this is a consequence of changes in the penetration rate of carrier fluid into the paper.

At very low pH's, the polymer is substantially cationized, and as such results in poor wetting of the paper by the carrier fluid. This can be seen from the data in Table 4 wherein there are presented fluid compatibility data of the cationic polymeric amine and the carrier fluid. The fluid compatibility was gauged by putting drops of the two fluids side by side on a microscopic slide and examining the interpenetration. The results are reported on a scale of one to five, with a five rating indicating no mixing to almost no mixing and a one rating indicating complete to almost complete mixing. Thus it can be seen that whereas poly(allylamine hydrochloride) at a pH of 2.37 has a rating of between 4 & 5 and one hour adhesion loss of 83%, by raising the solution pH to 11 the interpenetration rating improved to a 3 and when applied to the paper with resulting paper surface pH of 8.4, the one hour adhesion loss was 21.4%. As the pH is increased, increasing amounts of the polymer are caused to be in the base or uncationized form, which results in significant improvement in the wetting of the paper surface by the non polar carrier fluid and corresponding improvement in the one hour adhesion results. For the poly(allylamine hydrochloride), at each of the reported pH's adhesion losses were very low (less than 2.5%) from tape test measurements done 24 hours later thereby indicating that over this time period the carrier fluid had penetrated into the paper. Similar results can be seen for the poly(vinylamine hydrochloride).

There can be cases where there is total incompatibility between the cationic polymer and the carrier fluid over a wide range of pH. This could be particularly true of quaternary ammonium compounds that retain the charge over a wide range of pH. Thus, referring to Table 4, it can be seen that both poly(2-hydroxy-3-methacryloxypropyl trimethyl ammonium chloride) and poly(acrylamide/methacryloxyethyl trimethyl ammonium bromide) have a rating of 5 (no miscibility) and consequently exhibited inadequate one hour and 24 hour results for the specific carrier fluid. This is indicative of very slow to almost no drainage of the carrier fluid. On the other hand, poly(2-methacryloxyethyl trimethyl ammonium bromide) which had a rating of less than 4 gave adequate adhesion results with a loss of approximately 22% and over time improved to a loss of less than 5%.

It should be recognized that the rating resulting from the microscopic slide examination can only give qualitative guidance to trends and the actual state of the polymeric amine, that is percent cationized, will be governed by the paper surface pH, which in turn is impacted by the type of base paper as characterized by its surface pH before application of the polymeric amine and its buffering capability. Even though the polymeric amine compatibility was examined at the higher solution pH which, when applied to the paper, resulted in the reported paper surface pH, the results are clearly indicative of the directionality in fluid compatibility and hence adhesion results as a function of paper surface pH. However, it should clearly be understood that the surface pH of the coated paper surface will be the determinant of the polymer state.

At lower pH, where the polymer has increasing concentration of the cationized polymeric form, the surface becomes increasingly polar, thereby causing an increasingly slower drainage of the non-polar carrier fluid as indicated by the poor one hour adhesion data in Table 3 (simulating immediate adhesion results in Indigo printing machines). However, there can be very good adhesion once the carrier fluid has substantially drained from the paper surface as indicated by the very good adhesion data at 24 hours. It is believed that in the absence of the carrier fluid, the formation of ionic bonds between the pigmented polymer and the polymeric amine lead to strong adhesion results.

If a relatively weaker base is used it would be substantially uncationized at relatively lower paper surface pH. This can be seen by examining the optimum adhesion performance at a loss of 13% for poly(4-vinylpyridine), which is known to be a weaker base, at a paper surface pH of 8 (see Table 2), whereas for poly(allylamine) the loss is 30% at a similar paper surface pH (see Table 3) and the paper surface pH had to be higher to further improve the adhesion results.

For quaternary polymeric amines, which remain cationized over a wide pH range, there is wider latitude in the paper surface pH wherein the polymer will provide satisfactory adhesion as long as the polymer is compatible with the carrier fluid and the pigmented polymer.

Based on an analysis of the data presented in Tables 2 through 4, it can be seen that the test procedure provided a number of suitable cationic polymeric materials for incorporation in the paper of the invention to be used as the receiver for images formed by the liquid electrophotographic methods carried out in the HP/Indigo digital offset printing machines.

Any ink jet printing apparatus such as the Hewlett Packard Desk Jet can evaluate the suitability of paper for ink jet printing. Ink jet printed samples can be evaluated for cyan, magenta, yellow and black image density together with water fastness and edge quality.

The image densities were measured using the Spectrolino Model Densitometer available from Macbeth.

The water fastness was measured by printing a column of cyan, magenta and yellow densities on paper, allowing the paper to dry for 15 minutes and then immersing a portion of the printed column on the paper in a water bath for 30 seconds. The paper was then withdrawn from the water bath and the water fastness was evaluated by measuring the difference in density between the immersed and non-immersed portions of the sample together with the width and density loss in the edge band created at the waterline. The data were reported by assigning a letter grade. The letter grade A was given for a paper with no loss in density and no noticeable waterline. A letter grade B was given for almost no loss in density and just a noticeable waterline. The letter grade C was given for a significant loss in density and a waterline band with a larger density loss. The letter grade D was given for a higher loss in density and a significant width waterline band with extremely low density. A letter grade E was given for a very large density loss and a very wide waterline band with complete loss of density.

It can be seen from the data in Table 5 that the presence of the polymeric vinylamine on the paper surface substantially increased the image density, and water fastness compared to that of the base paper without the polymeric amine. Further, as the paper surface pH was varied from a low of 6.55 to 7.27 there was no noticeable trend in image density. For water fastness, it can be seen that the best water fastness is indicated at paper surface pH of 6.55 and 6.80. Further, as the paper surface pH is increased beyond 7.27 to 7.87, both image density and water fastness degrade appreciably. It can be appreciated that although these data have been presented for only one polymeric amine, a similar screening procedure can be carried out for any of the polymeric amines that can be utilized in accordance with the invention.

The suitability for dry electrophotographic printing can be evaluated by printing a suitable test target in any laser jet dry toner printer or copying machine such as for example a Xerox DocuColor printer. The image quality data are presented in Table 6.

It can be seen from the data in Table 6 that image densities are essentially unchanged for paper surface pH ranging from about 6.5 to 7.9. Thus, there can be pH targeting latitude with respect to dry electrophotography image quality performance.

It is evident from the above results that modulating the degree by which the paper surface pH is higher than the pH of the interior of the paper will determine the suitability of the paper for eletrophotographic or ink jet printing methods or a combination of these methods. This is because the paper surface pH will impact the percentages of the polymeric amine in the cationized form and uncationized form.

For example, we have shown above that for optimal adhesion performance in wet electrophotographic methods utilizing a non-polar carrier fluid the polymeric amine should be significantly in the uncationized form. The pKa of the material, when available, can serve as a guide. Thus, for a primary or secondary amine having a pKb of about 6.0 and a corresponding pKa of about 8.0, the polymer will be 50% uncationized at a surface pH of 8, greater than 50% uncationized at a surface pH greater than 8 and greater than 50% cationized at surface pH less than 8.

One can then reason that for the paper to perform in a plurality of printing modalities ranging from electrophotographic to ink jet, the paper surface pH should be such that the polymeric material on the paper surface is sufficiently uncationized or its behavior sufficiently non-polar to provide adequate drainage of the non-polar carrier from the paper surface and hence good adhesion, while at the same time having an adequate amount of the cationized form for good performance in ink jet printing methods, particularly for good water fastness. It can be further reasoned that this result is most likely to occur in the vicinity of the pKa of the chosen polymeric material.

The tailoring of paper including a specific preferred cationic polymeric material, i.e., BASF Catiofast VHF poly(vinylamine) for use with a number of printing modalities will now be discussed. For example, in order to use paper including this polymeric material as the receiver material in wet electrophotographic printing methods utilizing a non-polar carrier fluid, it was shown earlier that the highest carrier fluid penetration rate and consequently the best adhesion results immediately after printing are obtained when the paper surface pH is such that a majority of the amine groups are uncationized. Thus, for Catiofast VHF poly(vinylamine), it can be seen from the data in Table 3 that at a paper surface pH of 6.55 the one hour adhesion results were quite poor at 36%, and at a paper surface pH of 7.30 good adhesion performance was obtained. Further, it can be seen from the data in Tables 2 and 3 that the adhesion performance was optimal at paper surface pH closer to 8.4. Thus if the paper were being tailored for optimal performance in HP/Indigo Liquid Electrophotography printers, the paper surface pH should be raised from 6.55 (pH of the interior or base paper) to 7.3 and higher, and preferably to a pH of 8.4 and above.

As the surface pH of paper described above is lowered, an increasing fraction of the polymer will be present in the cationized form. Thus, it can be seen from the data in Table 5 that at a paper surface pH of 6.80 and lower the paper performs optimally for ink jet printing, particularly with respect to water fastness. Consequently, for tailoring the paper according to one or more embodiments of the invention for generally optimum performance in ink jet printing modalities, as evident from the data in Table 5, for generally optimum results, the paper surface pH should be in range of from 6.55 to 6.8.

It can be seen from the data in Table 6 that for the paper surface pH range of 6.6 to 7.9, since image quality is unchanged, the paper according to this invention can have generally optimal dry electrophotographic performance anywhere in the examined pH range of 6.6 to 7.9

Thus, it can be seen that on the basis of the data in Tables 2 through 6, that the specifically chosen base paper can be tailored, according to the invention, for use in wet and dry electrophotographic printing methods, and ink jet printing methods, by raising the pH of the interior of the paper from 6.55 to a paper surface pH in the range of 7.00to 7.3

It should be noted here that for quaternary polymeric amines which remain cationized over a broad pH range, there will be a wider latitude in the paper surface pH that can be deployed, as long as the quaternary amine is compatible with the carrier fluid used in wet electrophotographic methods. The compatibility can be determined by the test described earlier.

Thus, it has been shown that by controlling the degree by which the paper surface pH is higher than the interior pH of the paper, the paper can be tailored for either ink jet and dry electrophotographic printing methods or wet electrophotographic methods or for a plurality of imaging methods spanning electrophotographic and ink jet printing modalities.

The pH of the cationic polymer mixture from which the cationic polymer is applied to the paper can be used to regulate the degree by which the paper surface pH is higher than the pH of the interior of the paper. For the paper surface pH to be higher than the interior pH of the paper, the pH of the cationic polymer mixture should be higher than the pH of the interior of the paper. Generally, the higher the pH of the cationic amine polymer mixture the higher will be the resulting surface pH of the paper.

It can be seen therefore that by following the above test procedure a variety of cationic polymeric amines can be screened to select an appropriate cationic polymer of specific molecular weight, degree of neutralization, and cationic polymer mixture pH to create the requisite adhesion and polymer mixture viscosity for maximizing retention at or near the surface to achieve good adhesion performance and image quality for a variety of printing modalities

The preferred cationic polymeric materials incorporated in paper for use with these printing machines are poly(vinylamine), poly(allylamine), poly(N-methylvinylamine), poly(vinylpyridine) and poly(2-methacryloxyethyl trimethyl ammonium bromide). Additionally, particularly for printing applications that are inclusive of wet electrophotographic printing methods, data presented and discussed above have shown that depending on the compatibility of the carrier fluid and the cationic polymer other quarternary compounds can also be suitable for use.

It was stated earlier that for electrophotographic printing the paper receiver material should also have a high surface strength so as to prevent unprinted area ghosting, or spurious images appearing on the receiver surface. A primary-requirement of the binder material then is to strongly bind typical paper additives such as calcium carbonate, clay, titanium dioxide and short, medium and long fibers in order to provide a hard paper surface, which is substantially free from loose particles and fibers. Additionally, it was also stated that the paper surface should preferably remain hard at the temperatures and pressures encountered during image transfer so as to prevent unprinted area ghosting, or spurious images appearing on the paper surface. The binder material should have sufficient binding strength to the typical paper additives so as to minimize or substantially eliminate abrasion and transfer of such paper additives and fibers during image transfer. Thus, the binder material should be substantially unaffected with respect to its binding strength with respect to paper fibers, fillers, etc. at the temperature of the paper during transfer.

Additionally, for the case of liquid electrophotographic printing methods and ink jet printing methods, the binder material should also be compatible with the carrier fluid or dispersant for the pigmented polymer particles, or the ink carrier. Upon application of the carrier fluid containing the pigmented polymer particles, the fluid should wet the paper and drain from the surface. It should be noted that for ink jet printing methods, given the presence of a mordant such as the polymeric amines according to the invention, one has an additional degree of freedom to regulate the rate of ink carrier fluid penetration into the paper surface via the type and amount of the selected binder.

Typical suitable binder materials which are useful in accordance with the invention are starches, such as non-ionic starches, starch derivatives such as, but not limited to, etherified and esterified starches and hydrophobically modified starches, latexes, proteins, alginates, vegetable gums, and cellulose derivatives such as, for example, carboxymethylcellulose, hydroxyethylcellulose and the like. The binder materials may be present in the paper individually or in combination. As stated earlier, for a preferred embodiment, the binder material is present in the paper in an amount of from about 0.25 to about 10.0 lbs/3300 ft², and particularly preferably from about 1.0 lbs to about 7.0 lbs/3300 ft² of finished paper.

The respective amounts of the cationic polymeric and the binder materials, which are utilized in any specific paper composition, are determined in part by percent of active functional groups in the molecule. The amounts of the cationic polymeric material and binder material in the paper composition can also be a function of the surface finish of the paper. The optimum amounts of cationic polymer(s) and binder material(s) in any specific paper designed to be used with any specific printing or copying machine can be determined by routine scoping experiments. As discussed previously, for good image quality there must be maximum pigmented polymer transfer to the paper receiver material for electrophotographic method, and maximum pigmented polymer, or ink, retention by the paper surface for electrophotographic and ink jet printing methods. The smoothness of the paper surface can have a significant impact on both the adhesion of the toner particles to the paper surface as well as on the “ghosting” phenomenon discussed earlier.

The Sheffield method, described in TAPPI Test T-538, OM-96, which is listed in TAPPI Test Methods (1996-1997), is a commonly accepted technique for measuring the surface smoothness of paper. The paper smoothness is inversely proportional to the Sheffield number, i.e., the higher the Sheffield numbers the rougher the paper surface. Generally, the Sheffield smoothness of the paper of the invention is from about 20 to about 400.

A preferred printing paper of the invention comprises from about 0.20 to about 10.0 lbs. of a polymeric primary amine, poly(allyl amine) or poly (vinyl amine) or a secondary amine poly (N methyl vinyl amine), or a heterocyclic amine poly(vinylpyridine), and about from about 1.0 to about 7.0 lbs of Ko-Film 280 starch, or FK-85 starch or FK-55 starch, each based on 3300 ft² of finished paper.

The electrophotographic printing methods provided according to the invention include those where the pigmented polymer toner particles are applied to the latent electrostatic image in a dry or wet composition with direct or indirect (offset) image transfer to receiver, and wherein an image is formed on a paper receiver material that includes at least one-cationic polymeric amine and at least one binder material.

In a preferred embodiment the paper used in these printing methods does not have more than about 20% by weight of mechanical fiber and particularly preferably not more than about 10% by weight. In another preferred embodiment the paper used in these printing methods includes from about 0.1 to about 18.0 lbs/3300 ft² of finished paper of at least one cationic polymeric amine material and from about 0.25 to about 10.0 lbs/3300 ft² of finished paper of at least one binder material, and particularly preferably from about 0.2 to about 10.0 lbs/3300 ft² of cationic polymeric amine material and from about 1.0 to about 7.0 lbs/3300 ft² of at least one binder material.

Preferred electrophotographic methods are those digital offset printing methods wherein an electrostatic latent image formed on a photoconductive surface, typically by applying a substantially uniform electrostatic charge to the photoconductive surface and irradiating the charged surface with image-modulated laser beam(s), is rendered visible with a liquid toner composition, transferred to a heated intermediate transfer surface and transferred from the latter to the final paper receiver material. Digital offset printing methods are well known in the art and therefore extensive discussion of such methods is not required here.

An imaging method of this type is described in U.S. Pat. No. 4,708,460. There is described in the '460 patent an apparatus wherein an image initially formed on a photoconductive surface by development with a liquid developer composition is transferred to an intermediate member positioned closely to the photoconductive member. The image is subsequently simultaneously transferred to the receiver and fused thereto. The printing paper of the invention is useful as the receiver sheet according to this method.

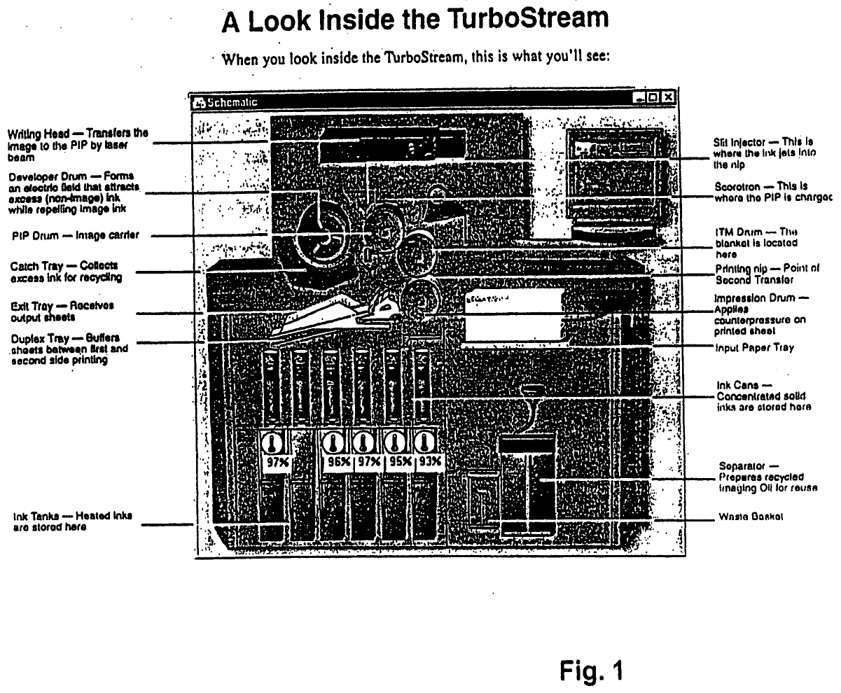

The paper of the invention may be used as the receiver for images formed by any suitable electrophotographic printing machine. FIG. 1 shows one particular printing machine, the Indigo TurboStream 1000 digital offset printing machine, having a developer drum that attracts excess non-image ink while repelling image ink, a PIP drum, which carries the image, an ITM drum on which a transfer blank is located, and an impression drum that forms a printing nip with the ITM drum. There are other commercially available printing machines with the same or different configurations, which carry out either digital offset printing or direct transfer printing

Electrophotographic printing apparatus and methods can be used to form monochromatic and polychromatic images. Polychromatic, or multicolor, images can be formed by two general methods. In one such method monochromatic color separation images, e.g., magenta, yellow and cyan, are formed successively and each is transferred, in registration, to the receiver. Digital offset printing machines that carry out this method include the HP/Indigo 1000 and 3000 printing machines in which each individual color separation image is formed, transferred to the intermediate transfer surface and then to the paper receiver in registration. In another such method, each color separation image is formed, transferred to an intermediate transfer surface in registration to form the multicolor image on the intermediate transfer surface and the multicolor image is then transferred to the paper receiver. Digital offset printing machines, which carry out this method, include the HP/Indigo 2000 and 4000 printing machines. Where the printing paper of the invention is used as the receiver for multicolor images formed according to the latter method it is preferred to utilize higher concentrations of the-cationic polymeric materials and binders since the contact time of the paper with the heated intermediate transfer surface is less than in the former method where the receiver is brought into contact with the heated intermediate transfer surface more than one time, e.g., three or four times.

The paper of the invention may be used as the receiver material for any ink jet printing method including those where aqueous and alcohol based inks are used and which can be carried out by any commercially available ink jet printers.

The paper of the invention may be produced by any conventional method that converts fiber slurry into paper, and may be bleached. Further, the cationic polymeric material and the binder material may be applied to the paper of the invention, either individually or in combination, at any point during the paper manufacture or they can be applied to the paper at any point after the paper manufacture process and before the formation of an image on the paper. The cationic polymeric material and the binder material may be mixed with the pulp fiber slurry, which is made into a paper sheet. The pulp fiber may be mainly composed of wood pulp and may contain additionally a fibrous material such as a synthetic pulp, synthetic fiber, glass fiber or the like. The cationic polymer and binder materials may be applied to paper by means of an air knife coater, a roll coater, a Champlex coater, a gravure coater, etc to a plain paper sheet or a coated sheet. Further, a plain paper or coated sheet may be immersed in a mixture of the materials, which may be a solution, dispersion, emulsion or combinations thereof, excess fluid removed and the paper dried.

In a preferred embodiment, both the cationic polymer and the binder are applied to the paper at a size press addition station during manufacture of the paper. Simultaneous addition of these materials at a size press addition station confers significant cost advantages. However, there may be other situations where it is advantageous to apply the cationic polymer and/or the binder to the paper other than at the size press addition station, including addition at any point after the paper manufacturing process and before the formation of the image on the paper.

The rheology of the cationic polymer and binder mixture at the size press addition station can be generally optimized for the chosen application method. That is, the viscosity of the cationic polymer mixture, under the conditions of being applied to the paper, as discussed earlier, should be sufficiently high so as to maximize retention of the cationic polymer and binder materials at or very near the paper surface. For a specific cationic polymer and binder, maximizing the percent solids of the cationic polymer mixture can also favorably impact the viscosity. However, as stated earlier, the maximum viscosity at the time of application to the paper should be kept below the allowable maximum for the chosen application method. In a preferred embodiment, the pH of the polymeric mixture is greater than about 6.55, and preferably less than 11.5.

TABLE 1
COMMERCIAL DIGITAL PAPER PRODUCTS
ADHESION PERFORMANCE IN LIQUID
ELECTRPHOTOGRAPHY

| | | | DWELL TIME | |
|---|---|---|---|---|
| | ITM TEMP | | MILLI | Mean Loss 1 Hr |
| TYPE OF PAPER | 0 C. | TAPE USED | SECONDS | After Transfer % |
| Base Paper Without | 105° C. | CELLOPHANE | 1000 | 38.30 |
| Polymeric Amine | | TAPE HIGHLAND | | |
| | | 6200 CLEAR | | |
| Hammermill Color | 105° C. | CELLOPHANE | 1000 | 37.00 |
| Copy | | TAPE HIGHLAND | | |
| | | 6200 CLEAR | | |
| Hammermill Color | 105° C. | CELLOPHANE | 250 | 46.90 |
| Copy | | TAPE HIGHLAND | | |
| | | 6200 CLEAR | | |
| Georgia Pacific | 105° C. | CELLOPHANE | 1000 | 51.45 |
| Microprint | | TAPE HIGHLAND | | |
| | | 6200 CLEAR | | |
| Georgia Pacific | 105° C. | CELLOPHANE | 250 | 56.13 |
| Microprint | | TAPE HIGHLAND | | |
| | | 6200 CLEAR | | |
| Xerox Color | 105° C. | CELLOPHANE | 1000 | 39.36 |
| Xpressions | | TAPE HIGHLAND | | |
| | | 6200 CLEAR | | |
| Xerox Color | 105° C. | CELLOPHANE | 250 | 44.73 |
| Xpressions | | TAPE HIGHLAND | | |
| | | 6200 CLEAR | | |

TABLE 2
Adhesion Performance Of Polymeric Amines For Liquid Electrophotography

| | | | Surface pH | Mean Loss | Mean Loss |
|---|---|---|---|---|---|
| | | Coverage | Of Coated | 1 Hour | 24 Hours |
| Sample Description | Amine Type | #/Ream | Sample | After Transfer % | After Transfer % |
| Base Paper Without | | | 6.55 | 38.3 | Basically |
| Polymeric Amine | | | | | Unchanged |
| Poly (allylamine | Primary | 0.9 | 8.4 | 21.4 | <2.5% |
| hydrochloride) | | | | | |
| Polyvinylamine | Primary | 0.93 | 10.03 | 9.1 | <2.5% |
| hydrochloride | | | | | |
| Polyvinylamine (BASF | Primary | 1.37 | 8.39 | 9.1 | <2.5% |
| Catiofast VFH) | | | | | |
| Poly N-Methylvinylamine | Secondary | 2.74 | 9.83 | 8.3 | <2.5% |
| Poly 4-Vinyl Pyridine | Heterocyclic | 1.56 | 8.1 | 13.2 | <2.5% |
| 60 K | | | | | |
| Basoplast 265d | Quarternary | 1.05 | 8.53 | 16.8 | <2.5% |
| | Amine/Acrylonitrile | | | | |
| | Co polymer | | | | |
| Poly(2-methacryloxy | Quarternary | 1.12 | 7.25 | 21.7 | <2.5% |
| ethyltrimethyl ammonium | | | | | |
| bromide) | | | | | |

TABLE 3
Surface pH Impact On Adhesion For Liquid Electrophotography

| | | | | Surface pH | | Mean | |
|---|---|---|---|---|---|---|---|
| | Coverage #/ | Solution | | Of Coated | | Loss | Mean Loss |
| Sample Description | Ream | pH | | Sample | | 1 Hr % | 1 Day % |
| Poly (allylaminehydrochloride) | 0.83 | 2.37 | pH | 6 | pH | 83.07 | <2.5% |
| Poly (allylaminehydrochloride) | 0.9 | 4.92 | pH | 6.38 | | 84.38 | <2.5% |
| Poly (allylaminehydrochloride) | 0.9 | 6.69 | pH | 6.47 | | 80.62 | <2.5% |
| Poly (allylaminehydrochloride) | 0.9 | 8.49 | pH | 6.95 | | 44.64 | <2.5% |
| Poly (allylaminehydrochloride) | 2.24 | | | 8.08 | | 29.96 | <2.5% |
| Poly (allylaminehydrochloride) | 0.9 | 11.0 | pH | 8.4 | | 21.45 | <2.5% |
| Poly Vinyl Amine Chloride 10% Sol | 0.93 | 1.6 | pH | 6.01 | pH | 34.69 | <2.5% |
| Poly Vinyl Amine Chloride 10% Sol | 1.14 | 11.4 | pH | 9.2 | pH | 10.76 | <2.5% |
| Poly Vinyl Amine Chloride 10% Sol | 0.93 | | | 10.03 | pH | 9.11 | <2.5% |
| Polyvinylamine (BASF Catiofast | 3.35 | 6.5 | | 6.55 | | 36.39 | <2.5% |
| VFH) | | | | | | | |
| Polyvinylamine (BASF Catiofast | 3.35 | 7.5 | | 7.05 | | 20.26 | <2.5% |
| VFH) | | | | | | | |
| Polyvinylamine (BASF Catiofast | 3.15 | 8.65 | | 7.27 | | 16.84 | <2.5% |
| VFH) | | | | | | | |
| Poly N-Methyl Vinyl Amine 10% Sol | 1.31 | 10.52 | | 8.5 | pH | 10.32 | <2.5% |
| Poly N-Methyl Vinyl Amine 10% Sol | 2.74 | | | 9.83 | pH | 8.28 | <2.5% |

TABLE 4
Liquid Electrophotography Adhesion Results As A Function of Carrier Fluid Wettability

| | | | Surface pH | | Mean Loss | Mean Loss |
|---|---|---|---|---|---|---|
| | Coverage #/ | | Of Coated | Carrier Fluid | 1 Hour | 24 Hours |
| Sample Description | Ream | Solution pH | Sample | Wettability | After Transfer % | After Transfer % |
| Poly N-Methyl Vinyl Amine 10% Sol | 1.31 | 10.52 | 8.5 | 2 | 10.5 | <2.5% |
| Poly (allylamine hydrochloride) | 0.83 | 2.37 | 6 | Between 4 & 5 | 83.1 | <2.5% |
| Poly (allylamine hydrochloride) | 0.9 | 11 | 8.4 | 3 | 21.4 | <2.5% |
| Poly(2-methacryloxy ethyltrimethylammonium | 1.12 | 8 | 7.25 | <4 | 21.7 | <5% |
| bromide) | | | | | | |
| Poly(Butylacrylate/ | 1.31 | 8.5 | 7.35 | Between 4 & 5 | 43.9 | <15% |
| 2-Methacryloxyethyltrimethylammonium Bromide) | | | | | | |
| 80/20 | | | | | | |
| Poly(2-Vinyl-1-Methylpyridinium Bromide) | 0.75 | 10 | 7.82 | 5 | 52.5 | Slightly |
| | | | | | | Improved |
| Poly (Acrylamide/Methacryloxyethyl | 2.05 | 9 | 7.44 | 5 | 54.3 | Unchanged |
| trimethylammonium bromide) | | | | | | |
| 80/20 | | | | | | |
| Poly(2-hydroxy-3-methacryloxypropyl trimethyl | 0.56 | 9.5 | 7.7 | 5 | 35.3 | Almost |
| ammonium chloride | | | | | | Unchanged |

TABLE 5
Impact Of Coated Surface pH on Ink Jet Image Quality

| | | | Surface | | | | |
|---|---|---|---|---|---|---|---|
| | | | pH Of | Image | Image | Image | Image |
| | Covg #/ | Solution | Coated | Density | Density | Density | Water |
| Sample Description | Ream | pH | Sample | Magenta | Yellow | Black | Fastness |
| Base Paper Without Polymeric Amine | | | 6.55 | 1.17 | 1.14 | 1.35 | E |
| Polyvinylamine (BASF Catiofast VFH) | 4.11 | 6.60 | 6.55 | 1.39 | 1.42 | 1.43 | A-B |
| Series 9/24 4/2/1 20% Solids | | | | | | | |
| Polyvinylamine (BASF Catiofast VFH) | 4.50 | 7.00 | 6.80 | 1.36 | 1.40 | 1.42 | A-B |
| Series 9/24 4/2/1 20% Solids | | | | | | | |
| Polyvinylamine (BASF Catiofast VFH) | 4.50 | 7.24 | 7.00 | 1.35 | 1.41 | 1.41 | B |
| Series 9/24 4/2/1 20% Solids | | | | | | | |
| Polyvinylamine (BASF Catiofast VFH) | 4.50 | 7.51 | 7.05 | 1.36 | 1.37 | 1.41 | B |
| Series 9/24 4/2/1 20% Solids | | | | | | | |
| Polyvinylamine (BASF Catiofast VFH) | 4.70 | 8.00 | 7.10 | 1.35 | 1.41 | 1.40 | B |
| Series 9/24 4/2/1 20% Solids | | | | | | | |
| Polyvinylamine (BASF Catiofast VFH) | 4.50 | 8.65 | 7.27 | 1.34 | 1.41 | 1.40 | B-C |
| Series 9/24 4/2/1 20% Solids | | | | | | | |
| Polyvinylamine (BASF Catiofast VFH) | 3.52 | 10.90 | 7.87 | 1.16 | 1.22 | 1.38 | C-D |
| Series 9/24 4/2/1 20% Solids | | | | | | | |

TABLE 6
Impact Of Coated Surface pH on Dry Electrophotographic Image Quality

| | | | Surface | | |
|---|---|---|---|---|---|
| | | | pH Of | | Image |
| | Covg #/ | Solution | Coated | Image Density | Density |
| Sample Description | Ream | pH | Sample | Magenta | Black |
| Polyvinylamine (BASF Catiofast VFH) | 4.11 | 6.6 | 6.55 | 1.22 | 1.22 |
| Polyvinylamine (BASF Catiofast VFH) | 4.5 | 7 | 6.8 | 1.22 | 1.26 |
| Polyvinylamine (BASF Catiofast VFH) | 4.5 | 8.65 | 7.27 | 1.25 | 1.23 |
| Polyvinylamine (BASF Catiofast VFH) | 3.52 | 10.9 | 7.87 | 1.25 | 1.24 |

TABLE 7
SOURCING OF TESTED COMPOUNDS

| | | | | Polymer |
|---|---|---|---|---|
| | | Supplier | | Molecular Weight |
| Sample Description | Supplier | Product Number | CAS NO | Mw |
| Poly (allylamine hydrochloride) | Poly Sciences | 18378-100 | 71550-12-4 | 60000 |
| Poly 4-Vinyl Pyridine 60 K | Aldrich | 0 | 9017-40-7 | 60000 |
| Poly (vinylamine hydrochloride) | Poly Sciences | 23965-5 | 26336-38-9 | 25000 |
| Co Polymer Of Quarternary amine & acrylonitrile | BASF | Basoplast | | |
| | | 265d | | |
| Polyvinylamine | BASF | Catiofast | | |
| | | VFH | | |
| PEI Linear 25 K All | Poly Sciences | | 9002-98-6 | |
| Secondary Amine | | | | |
| Poly N-Methyl Vinyl Amine | Poly Sciences | 24038-5 | 31245-56-4 | |
| Poly(2-methacryloxy ethyltrimethylammonium | Poly Sciences | 21479-10 | 68912-04-9 | 50000 |
| bromide) | | | | |
| Poly(2-hydroxy-3- | Poly Sciences | 21427-10 | 25609-94-3 | |
| methacryloxypropyltrimethylammonium chloride | | | | |
| Poly(Butyl Acrylate/2- | Poly Sciences | 21744-10 | | |
| Methacryloxyethyltrimethylammonium | | | | |
| Bromide) | | | | |
| 80/20 | | | | |
| 21743 Poly (Acrylamide | Poly Sciences | 21743-10 | 35429-19-7 | 50000 |
| Methacryloxyethyltrimethylammonium | | | | |
| bromide) 80/20 | | | | |
| Polydiallyldimethylammonium chloride) | Poly Sciences | 19898-250 | 26062-79-3 | |

1. A paper composition comprising at least one amine group-containing cationic polymeric material and at least one binder material, said amine group containing cationic polymeric material including repeating units represented by the formula I or the formula III: 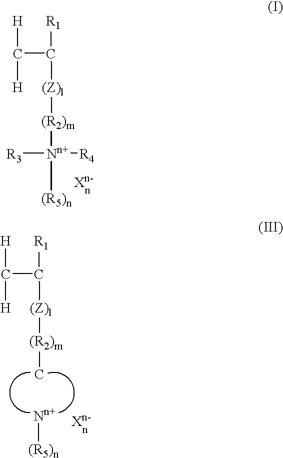
wherein,
R₁ is hydrogen or alkyl,
R₂ is alkyl or aryl;
R₃ and R₄ are each independently hydrogen, alkyl or aryl or R₃ and R₄, taken together with the nitrogen atom to which they are attached form a 3-10 member heterocyclic moiety;
R₅ is alkyl or aryl;
X is an anion;
Z is a linking group;
l is 0 or 1:
m is 0 or 1; and
n is 0 or 1;
wherein the surface pH of the paper is higher than the pH of an interior part of the paper.

2. A paper composition as defined in claim 1 comprising from about 0.1 to about 18.0 lbs/3300 ft² of finished paper of the at least one amine group-containing cationic polymeric material and from about 0.25 to about 10.0 lbs/3300 ft² of finished paper of the at least one binder material

3. A paper composition as defined in claim 1 comprising from about 0.20 to about 10.0 lbs/3300 ft² of finished paper of the at least one amine group-containing cationic polymeric material and from about 1.0 to about 7.0 lbs/3300 ft² of finished paper of the at least one binder material.

4. A paper composition as defined in claim 1 wherein said amine group containing cationic polymeric material is selected from the group consisting of poly(allylamine), poly(vinylamine), poly( N-methylvinylamine), poly(vinylpyridine), poly (2-methacryloxyethyltrimethyl ammonium bromide) and mixtures thereof.

5. A paper composition as defined in claim 1 wherein said binder material is selected from the group consisting of starch, derivatives of starch, latexes, proteins, alginates, vegetable gums and cellulose derivatives and mixtures thereof.

6. A paper composition as defined in claim 1 wherein said cationic polymeric material has a Vicat softening temperature which is equal to or less than about 90° C.

7. A paper composition as defined in claim 1 wherein said cationic polymeric material is substantially in the uncationized form.

8. A paper composition as defined in claim 1 wherein said cationic polymer is substantially in the cationized form.

9. A paper composition as defined in claim 1 wherein said paper has a surface pH of from about 6.5 to 10.5.

10. An imaging method comprising the steps of:
a) forming an image; and
b) transferring said image to a sheet of paper, said paper comprising a paper composition comprising at least one amine group-containing cationic polymeric material and at least one binder material, said amine group containing cationic polymeric material including repeating units represented by the formula I or the formula III: 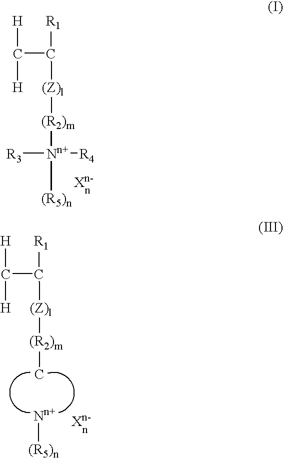
wherein,
R₁ is hydrogen or alkyl,
R₂ is alkyl or aryl;
R₃ and R₄ are each independently hydrogen, alkyl or aryl or R₃ and R_{4,} taken together with the nitrogen atom to which they are attached form a 3-10 member heterocyclic moiety;
R₅ is alkyl or aryl;
X is an anion;
Z is a linking group;
l is 0 or 1:
m is 0 or 1; and
n is 0 or 1;
wherein the surface pH of the paper is higher than the pH of an interior part of the paper.

11. The imaging method as defined in claim 10 wherein said paper comprises from about 0.1 to about 18.0 lbs/3300 f² of finished paper of said at least one cationic polymeric material and from about 0.25 to about 10.0 lbs/3300 ft² of finished paper of said at least one binder material.

12. The imaging method as defined in claim 11 wherein said paper comprises from about 0.2 to about 10.0 lbs/3300 ft² of finished paper of the at least one cationic polymeric material and from about 1.0 to about 7.0 lbs/3300 ft² of finished paper of the at least one binder material.

13. The imaging method as defined in claim 10 wherein said cationic polymeric material is selected from the group consisting of poly(allylamine), poly(vinylamine), poly( N-methylvinylamine), poly(vinylpyridine), poly (2-methacryloxyethyltrimethyl ammonium bromide) and mixtures thereof.

14. The imaging method as defined in claim 10 wherein step a) comprises forming said image on a photoconductive surface utilizing a liquid developer composition and transferring said image from said photoconductive surface to a heated intermediate transfer surface, and step b) comprises transferring said image from said intermediate transfer surface to said sheet of paper.

15. The imaging method as defined in claim 14 wherein during step b) said intermediate transfer surface has a temperature of from about 100° C. to about 200° C.

16. The imaging method as defined in claim 15 wherein said cationic polymeric material has a Vicat softening temperature of from about 10° C. to about 100° C. less than the temperature of the surface of said paper when it is in contact with said intermediate transfer surface.

17. The imaging method as defined in claim 16 wherein said cationic polymeric material has a softening temperature less than about 40° C.

18. The imaging method as defined in claim 14 wherein step a) comprises irradiating a substantially uniformly electrostatically charged photoconductive surface with an imagewise-modulated laser beam.

19. The imaging method as defined in claim 10 wherein step a) comprises forming said image on a photoconductive surface and further including the step of fusing said image to said paper sheet.

20. The imaging method as defined in claim 19 wherein said cationic polymeric material has a softening temperature equal to or less than 180° C.

21. An ink jet image forming method comprising forming an image on a paper receiver by applying an ink formulation containing an image forming material in a liquid carrier to the paper, said paper receiver being a paper comprising a paper composition comprising at least one amine group-containing cationic polymeric material and at least one binder material, said amine group containing cationic polymeric material including repeating units represented by the formula I or the formula 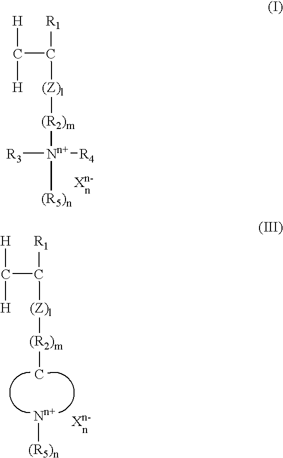
wherein,
R₁ is hydrogen or alkyl,
R₂ is alkyl or aryl;
R₃ and R₄ are each independently hydrogen, alkyl or aryl or R₃ and R_{4,} taken together with the nitrogen atom to which they are attached form a 3-10 member heterocyclic moiety;
R₅ is alkyl or aryl;
X is an anion;
Z is a linking group;
l is 0 or 1:
m is 0 or 1; and
n is 0 or 1;
wherein the surface pH of the paper is higher than the pH of an interior part of the paper.

22. A method for manufacturing paper comprising applying at least one amine group-containing cationic polymeric material and at least one binder material to a paper composition, wherein said at least one amine group-containing cationic polymeric material includes repeating units represented by the formula I or the formula III: 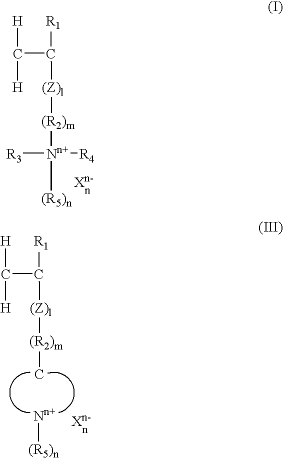
wherein,
R₁ is hydrogen or alkyl,
R₂ is alkyl or aryl;
R₃ and R₄ are each independently hydrogen, alkyl or aryl or R₃ and R₄, taken together with the nitrogen atom to which they are attached form a 3-10 member heterocyclic moiety;
R₅ is alkyl or aryl;
X is an anion;
Z is a linking group;
l is 0 or 1:
m is 0 or 1; and
n is 0 or 1;
wherein the surface pH of the paper is higher than the pH of an interior part of the paper.

23. The method as defined in claim 22 wherein said cationic polymeric material and said binder material are applied from a solution, dispersion, emulsion or combinations thereof.

24. The method as defined in claim 22 wherein said cationic polymeric material and said binder material are applied at a size press addition station.

25. The method as defined in claim 24 wherein said cationic polymeric material and said binder material are applied from a solution, dispersion, emulsion or combinations thereof having a pH of greater than about 6.0.

26. The method as defined in claim 22 wherein said cationic polymeric material is selected from the group consisting of poly(allylamine), poly(vinylamine), poly( N-methylvinylamine), poly(vinylpyridine), poly (2-methacryloxyethyltrimethyl ammonium bromide) and mixtures thereof.

27. A method for preparing a printing paper comprising the steps of:
providing a base paper having a pH value; and
applying onto the base paper a coating solution, dispersion, emulsion or combinations thereof including at least one cationic polymeric material and a binder material and having a pH higher than the pH of said base paper, wherein said at least one cationic polymeric material includes repeating units represented by the formula I or the formula III: 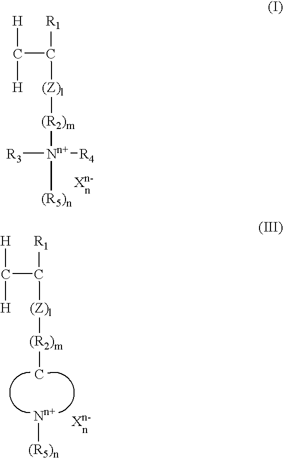
wherein,
R₁ is hydrogen or alkyl,
R₂ is alkyl or aryl;
R₃ and R₄ are each independently hydrogen, alkyl or aryl or R₃ and R₄, taken together with the nitrogen atom to which they are attached form a 3-10 member heterocyclic moiety;
R₅ is alkyl or aryl;
X is an anion;
Z is a linking group;
l is 0 or 1:
m is 0 or 1; and
n is 0 or 1;
wherein the surface pH of the paper is higher than the pH of an interior part of the paper.
